(19) United States
(12) Patent Application Publication
(10) Pub. No.: US 2024/0413574 A1
(43) Pub. Date: Dec. 12, 2024

(54) CONNECTOR STRUCTURE

(71) Applicant: SUMITOMO ELECTRIC INDUSTRIES, LTD, Osaka (JP)

(72) Inventor: Yasunori ASANO, Osaka-shi (JP)

(73) Assignee: SUMITOMO ELECTRIC INDUSTRIES, LTD, Osaka (JP)

(21) Appl. No.: 18/733,095

(22) Filed: Jun. 4, 2024

(30) Foreign Application Priority Data
Jun. 7, 2023 (JP) 2023-093965

(51) Int. Cl. H01R 13/629; H01R 12/77; H01R 13/514; H01R 13/518

(52) U.S. Cl. CPC H01R 13/629; H01R 12/771; H01R 13/514; H01R 13/518

(57) ABSTRACT

A connector structure includes a plurality of subconnectors stacked along a first direction. Each of the plurality of subconnectors includes: a front end surface parallel to the first direction; a plurality of insertion holes extending along a second direction intersecting the front end surface and opened on the front end surface; a first positioning prat located next to the plurality of insertion holes when viewed from the second direction; and a second positioning prat located next to the plurality of insertion holes when viewed from the second direction, and each of the plurality of subconnectors is positioned with respect to the mating connector by the first positioning prat and the second positioning prat.

### TECHNICAL FIELD

The present disclosure relates to a connector structure. The present application claims priority based on Japanese Patent Application No. 2023-093965 filed on Jun. 7, 2023, the entire contents of which are incorporated herein by reference.

### BACKGROUND

Japanese Unexamined Patent Publication No. 2017-069166 describes a connector structure including: a housing having a front end surface and a plurality of insertion holes opened on the front end surface; and a plurality of electric wires arranged in the plurality of insertion holes. Each electric wire of the connector structure described in Japanese Unexamined Patent Publication No. 2017-069166 is connected to each terminal of the mating connector.

### SUMMARY

A connector structure of the present disclosure includes a plurality of subconnectors stacked along a first direction; each of the plurality of subconnectors includes: a front end surface parallel to the first direction; a plurality of insertion holes extending along a second direction intersecting the front end surface and opened on the front end surface; a first positioning prat located next to the plurality of insertion holes when viewed from the second direction; and a second positioning prat located next to the plurality of insertion holes when viewed from the second direction, and each of the plurality of subconnectors is positioned with respect to the mating connector by the first positioning prat and the second positioning prat.

### BRIEF DESCRIPTION OF THE DRAWINGS

FIG. 1 is a front view of a connector structure according to an embodiment;

FIG. 2 is a front view of a subconnector shown in FIG. 1;

FIG. 3 is a plan view of the subconnector shown in FIG. 2;

FIG. 4 is a cross-sectional view of the subconnector taken along line IV-IV shown in FIG. 3;

FIG. 5 is a partially enlarged view of the connector structure shown in FIG. 1;

FIG. 6 is a front view of a connector structure according to a modification example; and

FIG. 7 is a partially enlarged view of the connector structure shown in FIG. 6.

### DETAILED DESCRIPTION

[Problem to be Solved by the Present Disclosure] For the connector structure described in Japanese Unexamined Patent Publication No. 2017-069166, for example, an increase in the amount of communication may be required, and in this case an increase in the number of insertion holes is assumed. However, when the number of insertion holes is increased, it is feared that the accuracy of alignment of each insertion hole with respect to the mating connector will be reduced and consequently communication performance will be reduced.

[Effects of the Present Disclosure] According to the present disclosure, a connector structure capable of suppressing a reduction in communication performance can be provided.

[Description of Embodiments of the Present Disclosure] First, the contents of embodiments of the present disclosure are listed and described.

A connector structure of the present disclosure is [1] “a connector structure including a plurality of subconnectors stacked along a first direction, in which each of the plurality of subconnectors includes: a front end surface parallel to the first direction; a plurality of insertion holes extending along a second direction intersecting the front end surface and opened on the front end surface; a first positioning prat located next to the plurality of insertion holes when viewed from the second direction; and a second positioning prat located next to the plurality of insertion holes when viewed from the second direction, and each of the plurality of subconnectors is positioned with respect to a mating connector by the first positioning prat and the second positioning prat”.

In the connector structure according to [1] above, each subconnector includes a first positioning prat and a second positioning prat, and is positioned with respect to the mating connector by the first positioning prat and the second positioning prat. That is, each subconnector is separately positioned with respect to the mating connector in a mutually independent state. Thereby, for example, as compared to a case where an integrated connector is positioned with respect to the mating connector, the accuracy of alignment of each insertion hole with respect to the mating connector can be improved. Therefore, even if the number of insertion holes increases with an increase in the amount of communication, a reduction in communication performance can be suppressed. Thus, by the connector structure, a reduction in communication performance can be suppressed.

The connector structure of the present disclosure may be [2] “the connector structure according to [1] above, in which each of the first positioning prat and the second positioning prat is a positioning pin”. Thereby, the accuracy of alignment of each insertion hole with respect to the mating connector can be improved with a simple configuration.

The connector structure of the present disclosure may be [3] “the connector structure according to [1] above, in which each of the first positioning prat and the second positioning prat is a positioning hole”. Thereby, the accuracy of alignment of each insertion hole with respect to the mating connector can be improved with a simple configuration.

The connector structure of the present disclosure may be [4] “the connector structure according to any one of [1] to [3] above, further including a fixing member surrounding the plurality of subconnectors when viewed from the second direction and bundling the plurality of subconnectors in which a gap allowing each of the plurality of subconnectors to be movable is present between the plurality of subconnectors and the fixing member”. Thereby, the plurality of subconnectors are stably fixed by the fixing member, and the movement of each subconnector is secured; thus, the accuracy of alignment of each insertion hole with respect to the mating connector can be improved.

The connector structure of the present disclosure may be [5] “the connector structure according to any one of [1] to [4] above, in which the plurality of insertion holes are configured by a first insertion hole row arranged along a third direction intersecting the first direction when viewed from the second direction and a second insertion hole row located next to the first insertion hole row in the first direction and arranged along the third direction when viewed from the second direction, when viewed from the second direction the first positioning prat is located next to the first insertion hole row and the second insertion hole row in the third direction, and when viewed from the second direction the second positioning prat is located on the opposite side to the first positioning prat with respect to the first insertion hole row and the second insertion hole row”. Thereby, while the number of insertion holes of the connector structure is secured, the accuracy of alignment of each insertion hole of each subconnector with respect to the mating connector can be improved.

The connector structure of the present disclosure may be [6] “the connector structure according to any one of [1] to [5] above, in which each of the plurality of subconnectors further includes an electric wire placed in at least one insertion hole among the plurality of insertion holes”. Thereby, the accuracy of alignment of the electric wire with respect to the mating connector can be improved.

The connector structure of the present disclosure may be [7] “the connector structure according to [6] above, in which the electric wire is each of a plurality of electric wires of a flexible flat cable”. Thereby, the accuracy of alignment of the plurality of electric wires of the flexible flat cable with respect to the mating connector can be improved.

The connector structure of the present disclosure may be [8] “the connector structure according to any one of [1] to [7] above, in which each of the plurality of subconnectors further includes an optical fiber placed in at least one insertion hole among the plurality of insertion holes”. Thereby, the accuracy of alignment of the optical fiber with respect to the mating connector can be improved.

The connector structure of the present disclosure may be [9] “the connector structure according to any one of [1] to [8] above, in which when viewed from the second direction each of the plurality of subconnectors is symmetrical with respect to each of a center line parallel to the first direction and a center line parallel to a third direction intersecting the first direction”. Thereby, the flexibility of arrangement of subconnectors can be improved.

[Details of Embodiments of the Present Disclosure] A specific example of a connector structure of the present disclosure will now be described with reference to the drawings. The present disclosure is not limited to these examples, but is indicated by the claims, and is intended to include all alterations within the meaning and scope equivalent to the claims. In the description of the drawings, the same elements are denoted by the same reference signs, and a repeated description is omitted.

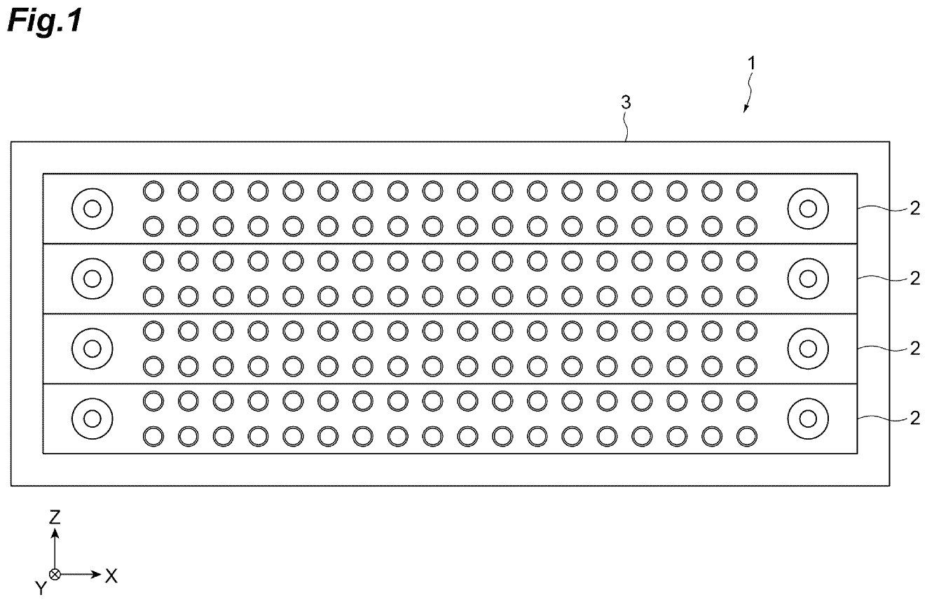

FIG. 1 is a front view of a connector structure according to the present embodiment. As shown in FIG. 1, a connector structure 1 includes a plurality of subconnectors 2 and a fixing member 3. The plurality of subconnectors 2 are stacked along a Z-axis direction (a first direction). The subconnectors 2 are independent of each other. Each subconnector 2 among the plurality of subconnectors 2 is movable with respect to the other subconnectors 2. The subconnectors 2 are not fixed to each other. However, subconnectors 2 may be lightly engaged with each other in a state of being movable together with each other.

The fixing member 3 has, for example, an annular shape. In the present embodiment, the fixing member 3 has a rectangular annular shape. The fixing member 3 surrounds the plurality of subconnectors 2 when viewed from a Y-axis direction (a second direction intersecting the first direction). The fixing member 3 bundles the plurality of subconnectors 2. The fixing member 3 is not fixed to any of the subconnectors 2. That is, each subconnector 2 is movable with respect to the fixing member 3.

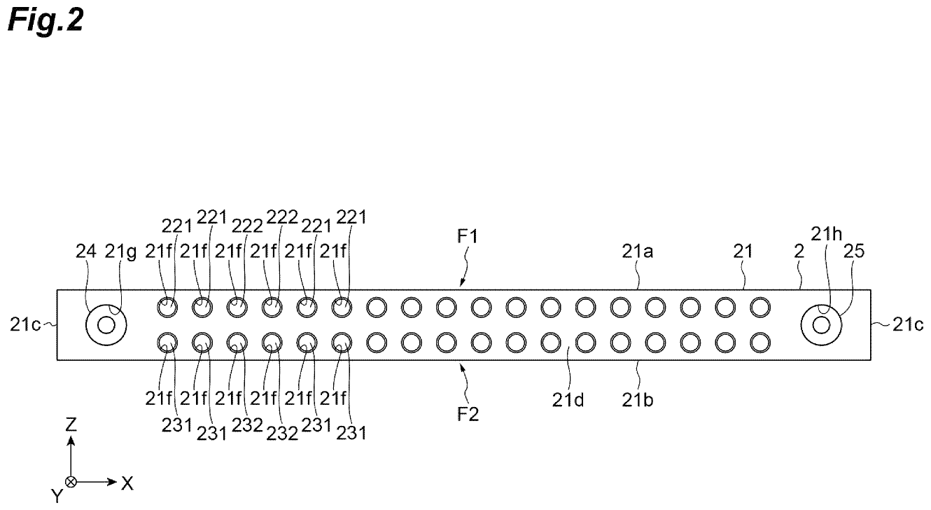

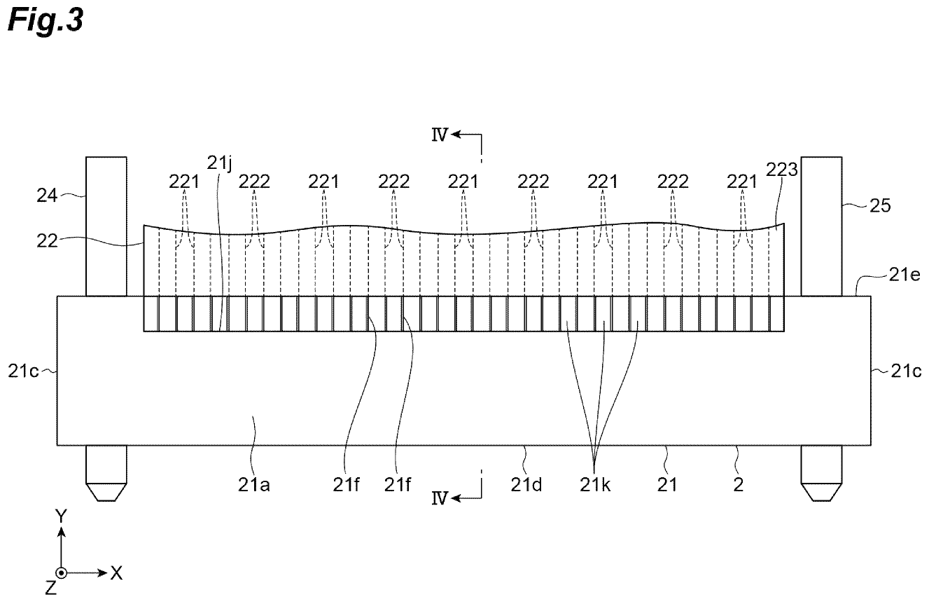

FIG. 2 is a front view of one subconnector 2 shown in FIG. 1. FIG. 3 is a plan view of the subconnector 2 shown in FIG. 2. As shown in FIGS. 2 and 3, the subconnector 2 includes a ferrule 21, a first cable 22, a second cable 23 (see FIG. 3), a first positioning prat 24, and a second positioning prat 25.

The ferrule 21 includes a first main surface 21a, a second main surface 21b, a pair of side surfaces 21c, a front end surface 21d, and a rear end surface 21e. Each of the first main surface 21a and the second main surface 21b is a flat surface intersecting the Z-axis direction. The second main surface 21b faces the opposite side to the first main surface 21a. The side surface 21c is a flat surface intersecting an X-axis direction (a third direction intersecting both the first direction and the second direction). The pair of side surfaces 21c face opposite sides to each other. Each of the front end surface 21d and the rear end surface 21e is a flat surface that intersects the Y-axis direction and is parallel to the Z-axis direction. The rear end surface 21e faces the opposite side to the front end surface 21d.

The ferrule 21 includes a first insertion hole row F1 and a second insertion hole row F2. The first insertion hole row F1 includes a plurality of insertion holes 21f arranged along the X-axis direction when viewed from the Y-axis direction. The second insertion hole row F2 is, when viewed from the Y-axis direction, located next to the first insertion hole row F1 in the Z-axis direction. The second insertion hole row F2 includes a plurality of insertion holes 21f arranged along the X-axis direction when viewed from the Y-axis direction. Thus, the plurality of insertion holes 21f of the ferrule 21 are configured by the first insertion hole row F1 and the second insertion hole row F2. The insertion hole 21f extends along the Y-axis direction intersecting the front end surface 21d, and is opened on each of the front end surface 21d and the rear end surface 21e.

The ferrule 21 includes a first through hole 21g and a second through hole 21h. Each of the first through hole 21g and the second through hole 21h is, when viewed from the Y-axis direction, located next to the first insertion hole row F1 and the second insertion hole row F2 in the X-axis direction. The second through hole 21h is, when viewed from the Y-axis direction, located on the opposite side to the first through hole 21g with respect to the first insertion hole row F1 and the second insertion hole row F2. Each of the first through hole 21g and the second through hole 21h penetrates the ferrule 21 in the Y-axis direction, and is opened on each of the front end surface 21d and the rear end surface 21e. The ferrule 21 is, when viewed from the Y-axis direction, symmetrical with respect to each of a center line parallel to the Z-axis direction and a center line parallel to the X-axis direction.

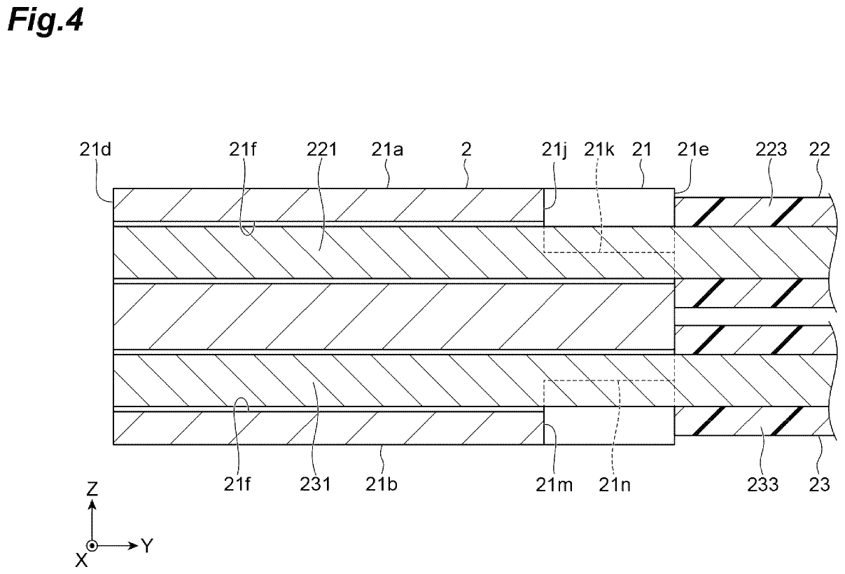

FIG. 4 is a cross-sectional view of the subconnector 2 taken along line IV-IV shown in FIG. 3. As shown in FIGS. 2 to 4, the first cable 22 is, for example, a flexible flat cable (FFC). The first cable 22 includes a plurality of electric wires 221, a plurality of electric wires 222, and a sheath 223. In the present embodiment, a pair of two electric wires 221 next to each other and a pair of two electric wires 222 next to each other are alternately arranged along the X-axis direction. The sheath 223 bundles the plurality of electric wires 221 and the plurality of electric wires 222. Each of front end portions of the electric wire 221 and the electric wire 222 is placed in the insertion hole 21f of the first insertion hole row F1 in a state of being exposed from the sheath 223. The front ends of the electric wire 221 and the electric wire 222 reach the front end surface 21d of the ferrule 21. The electric wire 221 functions as, for example, a working electrode. The electric wire 222 functions as, for example, a ground electrode.

Similarly to the first cable 22, the second cable 23 is, for example, a flexible flat cable (FFC). The second cable 23 includes a plurality of electric wires 231, a plurality of electric wires 232, and a sheath 233. In the present embodiment, a pair of two electric wires 231 next to each other and a pair of two electric wires 232 next to each other are alternately arranged along the X-axis direction. Two electric wires 221 of the first cable 22 and two electric wires 231 of the second cable 23 are arranged along the Z-axis direction. Two electric wires 222 of the first cable 22 and two electric wires 232 of the second cable 23 are arranged along the Z-axis direction. The sheath 233 bundles the plurality of electric wires 231 and the plurality of electric wires 232. Each of front end portions of the electric wire 231 and the electric wire 232 is placed in the insertion hole 21f of the second insertion hole row F2 in a state of being exposed from the sheath 233. The front ends of the electric wire 231 and the electric wire 232 reach the front end surface 21d of the ferrule 21. The electric wire 231 functions as, for example, a ground electrode. The electric wire 232 functions as, for example, a working electrode.

As shown in FIG. 4, the ferrule 21 includes a first arrangement surface 21k and a second arrangement surface 21n. Each of the first arrangement surface 21k and the second arrangement surface 21n is a flat surface intersecting the Z-axis direction. The first arrangement surface 21k faces the same side as the first main surface 21a, and is recessed from the first main surface 21a. The position of the first arrangement surface 21k in the Z-axis direction substantially coincides with the center position of the insertion hole 21f of the first insertion hole row F1. The first arrangement surface 21k and the first main surface 21a are coupled by a first coupling surface 21j. The first coupling surface 21j is a flat surface intersecting the Y-axis direction. On the first arrangement surface 21k, the insertion hole 21f of the first insertion hole row F1 is opened toward the same side as the first arrangement surface 21k. That is, on the first arrangement surface 21k, the insertion hole 21f forms a groove. In this case, each of the electric wire 221 and the electric wire 222 can be guided to the front end surface 21d in a state of being placed in the insertion hole 21f (groove) on the first arrangement surface 21k.

The second arrangement surface 21n faces the same side as the second main surface 21b, and is recessed from the second main surface 21b. The position of the second arrangement surface 21n in the Z-axis direction substantially coincides with the center position of the insertion hole 21f of the second insertion hole row F2. The second arrangement surface 21n and the second main surface 21b are coupled by a second coupling surface 21m. The second coupling surface 21m is a flat surface intersecting the Y-axis direction. On the second arrangement surface 21n, the insertion hole 21f of the second insertion hole row F2 is opened toward the same side as the second arrangement surface 21n. That is, on the second arrangement surface 21n, the insertion hole 21f forms a groove. In this case, each of the electric wire 231 and the electric wire 232 can be guided to the front end surface 21d in a state of being placed in the insertion hole 21f (groove) on the second arrangement surface 21n.

As shown in FIGS. 2 and 3, the first positioning prat 24 is, for example, a positioning pin. The first positioning prat 24 is inserted in the first through hole 21g. In the present embodiment, the first positioning prat 24 is, for example, press-fitted in the first through hole 21g. The first positioning prat 24 is, when viewed from the Y-axis direction, located next to the first insertion hole row F1 and the second insertion hole row F2 in the X-axis direction. The front end of the first positioning prat 24 protrudes from the front end surface 21d of the ferrule 21. The rear end of the first positioning prat 24 protrudes from the rear end surface 21e of the ferrule 21.

The second positioning prat 25 is, for example, a positioning pin. The second positioning prat 25 is inserted in the second through hole 21h. In the present embodiment, the second positioning prat 25 is, for example, press-fitted in the second through hole 21h. The second positioning prat 25 is, when viewed from the Y-axis direction, located next to the first insertion hole row F1 and the second insertion hole row F2 in the X-axis direction. The second positioning prat 25 is, when viewed from the Y-axis direction, located on the opposite side to the first positioning prat 24 with respect to the first insertion hole row F1 and the second insertion hole row F2. The front end of the second positioning prat 25 protrudes from the front end surface 21d of the ferrule 21. The rear end of the second positioning prat 25 protrudes from the rear end surface 21e of the ferrule 21.

The subconnector 2 is positioned with respect to the mating connector by the first positioning prat 24 and the second positioning prat 25. Specifically, in a state where the front end surface 21d faces the mating connector, the subconnector 2 is connected to the mating connector such that each of the first positioning prat 24 and the second positioning prat 25 is inserted into a positioning hole of the mating connector. Thereby, the positional accuracy of the subconnector 2 with respect to the mating connector is secured, and therefore the positional accuracy of each insertion hole 21f with respect to the mating connector is secured. The subconnector 2 is, when viewed from the Y-axis direction, symmetrical with respect to each of a center line parallel to the Z-axis direction and a center line parallel to the X-axis direction.

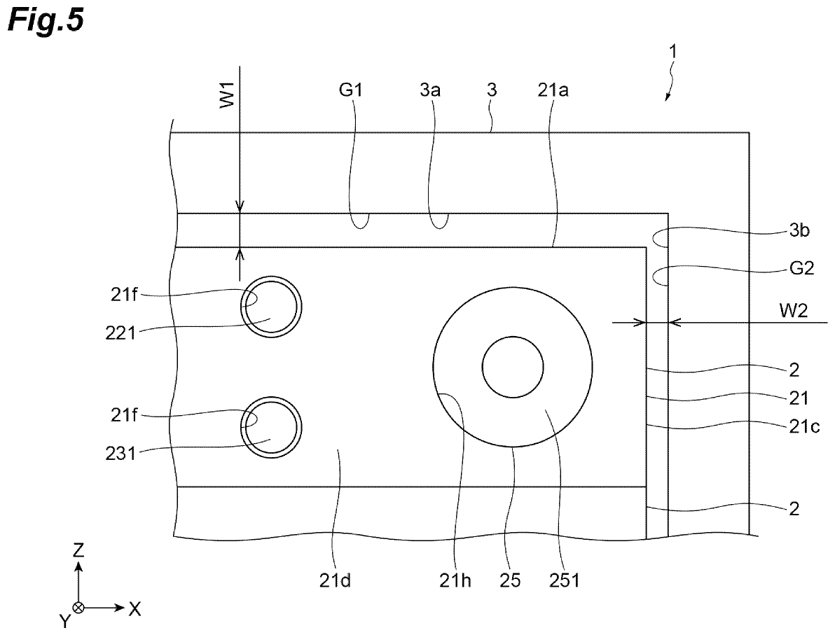

FIG. 5 is a partially enlarged view of the connector structure 1 shown in FIG. 1. As shown in FIG. 5, a first gap G1 and a second gap G2 allowing each subconnector 2 to be movable are present between the plurality of subconnectors 2 and the fixing member 3. Specifically, the fixing member 3 includes a pair of inner surfaces 3a and a pair of inner surfaces 3b. The inner surface 3a is, for example, a flat surface intersecting the Z-axis direction. The pair of inner surfaces 3a face each other in the Z-axis direction. The inner surface 3b is, for example, a flat surface intersecting the X-axis direction. The pair of inner surfaces 3b face each other in the X-axis direction.

The maximum width of the plurality of subconnectors 2 in the Z-axis direction is smaller than the distance between the pair of inner surfaces 3a. The first gap G1 exists between the first main surface 21a of the subconnector 2 closest to one inner surface 3a among the plurality of subconnectors 2 and the one inner surface 3a. The maximum width of the plurality of subconnectors 2 in the X-axis direction is smaller than the distance between the pair of inner surfaces 3b. The second gap G2 exists between the side surface 21c of the subconnector 2 and one inner surface 3b. In the present embodiment, the width W1 of the first gap G1 in the Z-axis direction is larger than the width W2 of the second gap G2 in the X-axis direction. The width W1 may be, for example, 0.2 mm to 2 mm, may be 0.5 mm to 1.5 mm, and is, as an example, about 1.0 mm. The width W2 may be, for example, 0.1 mm to 1.5 mm, may be 0.2 mm to 1.0 mm, and is, as an example, about 0.5 mm. Thus, since the first gap G1 and the second gap G2 are present between the plurality of subconnectors 2 and the fixing member 3, each subconnector 2 is movable with respect to the fixing member 3 while being bundled by the fixing member 3. The front end of the second positioning prat 25 includes a tapered surface 251. Thereby, the second positioning prat 25 is easily inserted into a positioning hole of the mating connector. Also the front end of the first positioning prat 24 includes a tapered surface.

As described hereinabove, in the connector structure 1, each subconnector 2 includes a first positioning prat 24 and a second positioning prat 25, and is positioned with respect to the mating connector by the first positioning prat 24 and the second positioning prat 25. That is, each subconnector 2 is separately positioned with respect to the mating connector in a mutually independent state. Thereby, for example, as compared to a case where an integrated connector is positioned with respect to the mating connector, the accuracy of alignment of each insertion hole 21f with respect to the mating connector can be improved. Therefore, even if the number of insertion holes 21f increases with an increase in the amount of communication, a reduction in communication performance can be suppressed. Thus, by the connector structure 1, a reduction in communication performance can be suppressed.

Each of the first positioning prat 24 and the second positioning prat 25 is a positioning pin. Thereby, the accuracy of alignment of each insertion hole 21f with respect to the mating connector can be improved with a simple configuration.

The connector structure 1 includes a fixing member 3 surrounding the plurality of subconnectors 2 and bundling the plurality of subconnectors 2 when viewed from the Y-axis direction. A first gap G1 and a second gap G2 allowing each subconnector 2 to be movable are present between the plurality of subconnectors 2 and the fixing member 3. Thereby, the plurality of subconnectors 2 are stably fixed by the fixing member 3, and the movement of each subconnector 2 is secured; thus, the accuracy of alignment of each insertion hole 21f with respect to the mating connector can be improved.

The plurality of insertion holes 21f of the ferrule 21 are configured by a first insertion hole row F1 arranged along the X-axis direction when viewed from the Y-axis direction and a second insertion hole row F2 located next to the first insertion hole row F1 in the Z-axis direction and arranged along the X-axis direction when viewed from the Y-axis direction. The first positioning prat 24 is, when viewed from the Y-axis direction, located next to the first insertion hole row F1 and the second insertion hole row F2 in the X-axis direction. The second positioning prat 25 is, when viewed from the Y-axis direction, located on the opposite side to the first positioning prat 24 with respect to the first insertion hole row F1 and the second insertion hole row F2. Thereby, while the number of insertion holes 21f of the connector structure 1 is secured, the accuracy of alignment of each insertion hole 21f of each subconnector 2 with respect to the mating connector can be improved.

Each subconnector 2 includes a plurality of electric wires 221 and a plurality of electric wires 222 arranged in a plurality of insertion holes 21f. Thereby, the accuracy of alignment of the electric wire 221 and the electric wire 222 with respect to the mating connector can be improved.

Each of the electric wire 221 and the electric wire 222 is each of a plurality of electric wires of a flexible flat cable (a first cable 22). Thereby, the accuracy of alignment of the plurality of electric wires of the flexible flat cable with respect to the mating connector can be improved.

Each subconnector 2 is, when viewed from the Y-axis direction, symmetrical with respect to each of a center line parallel to the Z-axis direction and a center line parallel to the X-axis direction. Thereby, the flexibility of arrangement of subconnectors 2 can be improved. For example, even if the first main surface 21a and the second main surface 21b of at least one subconnector 2 among the plurality of subconnectors 2 are inverted, the function of the connector structure 1 is not affected.

[Modification Example] Hereinabove, an embodiment of the present disclosure is described; however, the present disclosure is not limited to the above-described embodiment.

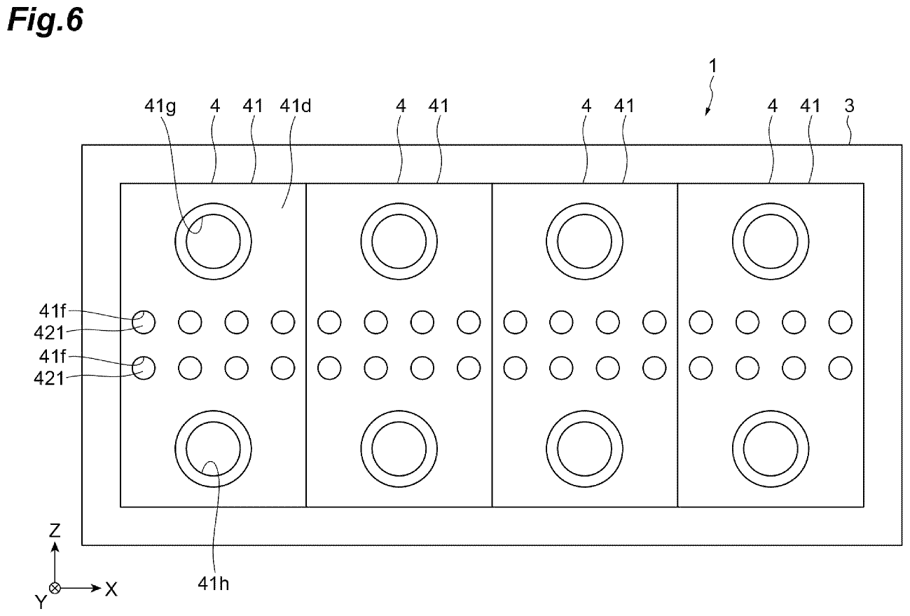

FIG. 6 is a diagram showing a connector structure according to a modification example. As shown in FIG. 6, the connector structure 1 may include a plurality of subconnectors 4 in place of the plurality of subconnectors 2. The plurality of subconnectors 4 are stacked along the X-axis direction. That is, in the modification example, the X-axis direction is a first direction.

The subconnector 4 includes a ferrule 41. The ferrule 41 includes a front end surface 41d that intersects the Y-axis direction (a second direction intersecting the first direction) and is parallel to the X-axis direction. The subconnector 4 includes a plurality of insertion holes 41f extending along the Y-axis direction and opened on the front end surface 41d. The subconnector 4 includes a plurality of electric wires 421 and a plurality of optical fibers 431 arranged in the plurality of insertion holes 41f. Thereby, the accuracy of alignment of both the electric wire and the optical fiber with respect to the mating connector can be improved.

The subconnector 4 includes a first positioning prat 41g and a second positioning prat 41h. The first positioning prat 41g is, when viewed from the Y-axis direction, located next to the plurality of insertion holes 41f in the Z-axis direction (a third direction intersecting both the first direction and the second direction). In the modification example, the Z-axis direction is the third direction. The second positioning prat 41h is, when viewed from the Y-axis direction, located on the opposite side to the first positioning prat 41g with respect to the plurality of insertion holes 41f.

Each of the first positioning prat 41g and the second positioning prat 41h is, for example, a positioning hole. Each of the first positioning prat 41g and the second positioning prat 41h penetrates the ferrule 41 in the Y-axis direction, and is opened on each of the front end surface 41d and the rear end surface of the ferrule 41. In a state where the front end surface 41d faces the mating connector, the subconnector 4 is connected to the mating connector such that a positioning pin of the mating connector is inserted into each of the first positioning prat 41g and the second positioning prat 41h. Also in such a case, the accuracy of alignment of each insertion hole 41f with respect to the mating connector can be improved with a simple configuration. At least one of the first positioning prat 41g and the second positioning prat 41h may be a groove or the like formed on the ferrule 41.

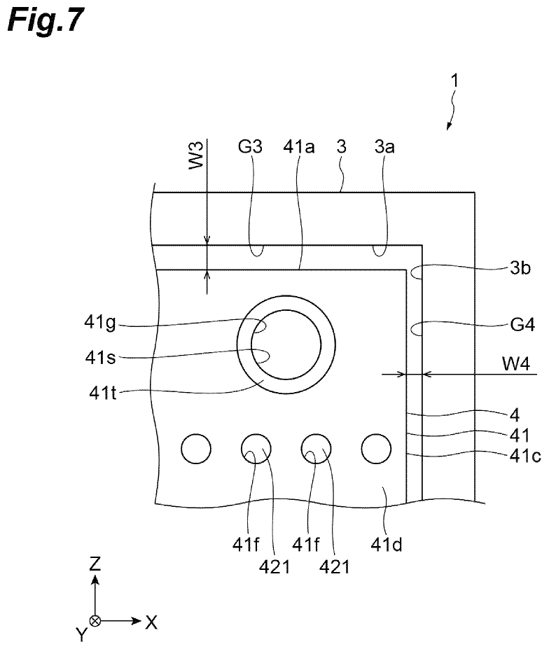

FIG. 7 is a partially enlarged view of the connector structure 1 shown in FIG. 6. As shown in FIG. 7, a first gap G3 and a second gap G4 allowing each subconnector 4 to be movable are present between the plurality of subconnectors 4 and the fixing member 3. The maximum width of the plurality of subconnectors 4 in the Z-axis direction is smaller than the distance between a pair of inner surfaces 3a of the fixing member 3. The first gap G3 exists between a first main surface 41a of the subconnector 4 and one inner surface 3a. The maximum width of the plurality of subconnectors 4 in the X-axis direction is smaller than the distance between a pair of inner surfaces 3b of the fixing member 3. The second gap G4 exists between a side surface 41c of a subconnector 4 and one inner surface 3b.

In the present embodiment, the width W3 of the first gap G3 in the Z-axis direction is larger than the width W4 of the second gap G4 in the X-axis direction. The width W3 may be, for example, 0.2 mm to 2 mm, may be 0.5 mm to 1.5 mm, and is, as an example, about 1.0 mm. The width W4 may be, for example, 0.1 mm to 1.5 mm, may be 0.2 mm to 1.0 mm, and is, as an example, about 0.5 mm. Also in this case, like in the embodiment, each subconnector 4 is movable with respect to the fixing member 3 while being bundled by the fixing member 3. The first positioning prat 41g includes a cylindrical surface 41s and a tapered surface 41t. Thereby, a positioning pin of the mating connector is easily inserted into the first positioning prat 41g. Also the second positioning prat 41h includes a cylindrical surface and a tapered surface.

What is claimed is:

1. A connector structure comprising
a plurality of subconnectors stacked along a first direction,
wherein each of the plurality of subconnectors includes:
a front end surface parallel to the first direction;
a plurality of insertion holes extending along a second direction intersecting the front end surface and opened on the front end surface;
a first positioning prat located next to the plurality of insertion holes when viewed from the second direction; and
a second positioning prat located next to the plurality of insertion holes when viewed from the second direction, and
each of the plurality of subconnectors is positioned with respect to a mating connector by the first positioning prat and the second positioning prat.

2. The connector structure according to claim 1, wherein each of the first positioning prat and the second positioning prat is a positioning pin.

3. The connector structure according to claim 1, wherein each of the first positioning prat and the second positioning prat is a positioning hole.

4. The connector structure according to claim 1, further comprising
a fixing member surrounding the plurality of subconnectors when viewed from the second direction and bundling the plurality of subconnectors,
wherein a gap allowing each of the plurality of subconnectors to be movable is present between the plurality of subconnectors and the fixing member.

5. The connector structure according to claim 4, wherein the gap includes a first gap located between the plurality of subconnectors and a first inner surface of the fixing member, the first inner surface intersects the first direction, and a second gap located between the plurality of subconnectors and a second inner surface of the fixing member, the second inner surface intersects the first inner surface.

6. The connector structure according to claim 5, wherein the width of the first gap is larger than the width of the second gap.

7. The connector structure according to claim 1, wherein the plurality of insertion holes are configured by a first insertion hole row arranged along a third direction intersecting the first direction when viewed from the second direction and a second insertion hole row located next to the first insertion hole row in the first direction and arranged along the third direction when viewed from the second direction,
when viewed from the second direction the first positioning prat is located next to the first insertion hole row and the second insertion hole row in the third direction, and
when viewed from the second direction the second positioning prat is located on an opposite side to the first positioning prat with respect to the first insertion hole row and the second insertion hole row.

8. The connector structure according to claim 1, wherein each of the plurality of subconnectors further includes an electric wire placed in at least one insertion hole among the plurality of insertion holes.

9. The connector structure according to claim 8, wherein the electric wire is each of a plurality of electric wires of a flexible flat cable.

10. The connector structure according to claim 1, wherein each of the plurality of subconnectors further includes an optical fiber placed in at least one insertion hole among the plurality of insertion holes.

11. The connector structure according to claim 1, wherein when viewed from the second direction each of the plurality of subconnectors is symmetrical with respect to each of a center line parallel to the first direction and a center line parallel to a third direction intersecting the first direction.
